(19) United States
(12) Patent Application Publication
(10) Pub. No.: US 2016/0053078 A1
(43) Pub. Date: Feb. 25, 2016

(54) INORGANIC FILLED LIGHTWEIGHT POLYURETHANE COMPOSITES

(71) Applicant: United States Gypsum Company, Chicago, IL (US)

(72) Inventors: Ashish Dubey, Grayslake, IL (US); Edmund Wright, II, Chicago, IL (US); Suman Sinha Ray, Chicago, IL (US)

(21) Appl. No.: 14/813,379

(22) Filed: Jul. 30, 2015

Related U.S. Application Data
(60) Provisional application No. 62/041,039, filed on Aug. 23, 2014.

(51) Int. Cl. C08K 3/36; B29C 43/00; C08J 5/00

(52) U.S. Cl. CPC C08K 3/36; C08J 5/00; B29C 43/003; C08J 2375/04; B29K 2049/00; B29L 2007/00

(57) ABSTRACT

Provided are construction products with a density in the range from about 10 pcf to about 125 pcf and comprising an inorganic filler cross-linked in a polyurethane matrix produced by an exothermic reaction between at least one alcohol having two or more reactive hydroxyl groups per molecule and at least one isocyanate having more than one reactive isocyanate group per molecule, wherein a molar ratio of the alcohol to the isocyanate is in the range from 0.25:1 to 5:1. Methods for making the products are provided as well.

### CROSS-REFERENCE TO RELATED APPLICATIONS

This application takes its priority from U.S. Provisional Patent Application 62/041,039, filed Aug. 23, 2014, the entire disclosure of which is incorporated herein by reference.

### TECHNICAL FIELD

This invention relates to lightweight inorganic filled polyurethane compositions for various construction applications and construction products made with the compositions, including panels, exterior wall sheathing, roof cover boards, roofing panels and the like, as well as methods for making construction products with a predetermined density.

### BACKGROUND

Various products such as boards, panels, tiles, ceiling tiles are commonly used during construction. Products made with gypsum (calcium sulfate dihydrate) are particularly suitable because of their light weight. During manufacturing of gypsum products, calcined gypsum (calcium sulfate hemihydrate) is used as a filler. It is mixed with water and other components into a slurry and shaped into various products. A great variety of gypsum-based building products is available from United States Gypsum Company, (Chicago, Ill.). Some of such products and methods of manufacturing are described in US patents assigned to United States Gypsum Company, including U.S. Pat. Nos. 1,500,452; 2,207,339; 5,922,447; 6,387,172; 7,364,015; 8,204,698 and other patents.

Products with different physical characteristics are needed during construction. For example, a roof tile or exterior wall is required to be water-resistant and a wall in a high-rise building must be light, yet this wall must withstand a certain pressure. There is also a need for products which are fire-resistant and easy to apply. It would be also advantageous if products with a range of densities can be manufactured from the same composition.

### SUMMARY OF THE INVENTION

At least some of these needs are addressed by lightweight inorganic filled polyurethane compositions provided in this disclosure. These compositions can be used as a material for manufacturing a great variety of construction products with desirable physical characteristics which are much needed in industrial applications. In some embodiments, a product with a predetermined density in the range from 10 pcf to 125 pcf can be made. Various products contemplated, including flat panels, a three-dimensional building components, a backboard, an exterior wall sheathing, roof cover boards, flooring panels, architectural wall panels, various architectural elements for building façade, synthetic wood and synthetic tiles.

One embodiment provides a construction product with a density in the range from about 10 pcf to about 125 pcf and comprising an inorganic filler cross-linked in a polyurethane matrix produced by an exothermic reaction between at least one alcohol having two or more reactive hydroxyl groups per molecule and at least one isocyanate having more than one reactive isocyanate group per molecule, wherein a molar ratio of the alcohol to the isocyanate is in the range from 0.25:1 to 5:1. In some embodiments, the isocyanate is selected from the group consisting of polycyclic and aromatic isocyanates. In some embodiments, the isocyanate is a fatty-acid derived isocyanate. In further embodiments, the isocyanate is selected from the group consisting of polymethylene polyphenyl isocyanates and 4,4′-diphenylmethane diisocyanate (MDI).

In some embodiments, the isocyanate can be selected from the group consisting of 2,4-toluene diisocyanate (TDI), xylene diiscyanate (XDI), meta-tetramethylxylylene diisocyanate (TMXDI), hydrogenated xylene diisocyanate (HXDI), naphthalene 1,5-diisocyanate (NDI), p-phenylene diisocyanate (PPDI), 3,3′-dimethyldiphenyl-4,4′-diisocyanate (DDDI), 1,6 hexamethyl diisocyanate (HMDI), 1,6 hexamethylene diiscyanate (HDI), 2,2,4-trimethylhexamethylene diisocyanate (TMDI), isophorone diisocyanate (IPDI), 4,4′-dicyclohexylmethane diisocyanate (H₁₂MDI) and norbornane diisocyanate (NDI), 4,4′-dibenzyl diisocyanate (DBDI).

Various polyols can be used for producing a polyurethane matrix, including polyols selected from the group consisting of a polyol obtained by reacting propane-1,2,3-triol (glycerol) and epoxyethane, a polyol obtained by reacting propane-1,2,3-triol (glycerol) and epoxypropane, polyester polyol, polyether polyol, acrylated polyol and natural polyol.

In some embodiments, the filler is a combination of fly ash, silica fume and perlite. In other embodiments, the filler can be at least one of the following compounds: calcium sulfate dihydrate, calcium sulfate hemihydrate, anhydrous calcium sulfate, synthetic calcium sulfate dihydrate, silica fume, hydraulic cement, blast furnace slag, fly ash, metakaoline, clay, ground glass, pumice, perlite, diatomaceous earth, expanded clay, expanded shale, expanded perlite, hollow ceramic microspheres, hollow glass microspheres and gas-filled expanded acrylic microspheres and expanded polystyrene microspheres, or any combination thereof.

In some embodiments, the construction product can further comprise fibers which can be selected from glass fibers, polymeric fibers, mineral wool fibers, cellulose, paper fibers or any combination thereof.

Further embodiments include methods for making a construction product with a predetermined density, in which at least the following steps are performed:
a) mixing a composition comprising at least one inorganic filler, at least one polyol and at least one polyisocyante;
b) pouring the composition into a mold;
c) applying compressive pressure to the mold, wherein the amount of compressive pressure applied is calculated such that to obtain a construction product with a pre-determined density; and
d) allowing the product to set.

These methods include those in which a product is produced with a predetermined density in the range from 10 pcf to 125 pcf. At least some of these methods can be performed with a composition formulated with at least two inorganic fillers selected from the group consisting of flyash class C, silica fume, perlite, cement, calcium sulfate hemihydrate, calcium sulfate dihydrate and calcium sulfate anhydrate. Various products with a predetermined density can be made by the methods, including such products as a flat panel, a three-dimensional building component, a backboard, an exterior wall sheathing, roof cover board, flooring panel, architectural wall panel, architectural element for building façade, synthetic wood and synthetic tile. In some embodiments, the methods are performed with an isocyanate selected from the group consisting of polymethylene polyphenyl isocyanates and 4,4′-diphenylmethane diisocyanate (MDI). In some embodiments, the isocyanate can be selected from the group consisting of 2,4-toluene diisocyanate (TDI), xylene diiscyanate (XDI), meta-tetramethylxylylene diisocyanate (TMXDI), hydrogenated xylene diisocyanate (HXDI), naphthalene 1,5-diisocyanate (NDI), p-phenylene diisocyanate (PPDI), 3,3′-dimethyldiphenyl-4,4′-diisocyanate (DDDI), 1,6 hexamethyl diisocyanate (HMDI), 1,6 hexamethylene diiscyanate (HDI), 2,2,4-trimethylhexamethylene diisocyanate (TMDI), isophorone diisocyanate (IPDI), 4,4′-dicyclohexylmethane diisocyanate (H₁₂MDI) and norbornane diisocyanate (NDI), 4,4′-dibenzyl diisocyanate (DBDI).

In some embodiments, the method is performed with a polyol selected from the group consisting of: a polyol obtained by reacting propane-1,2,3-triol (glycerol) and epoxyethane, a polyol obtained by reacting propane-1,2,3-triol (glycerol) and epoxypropane, polyester polyol, polyether polyol, acrylated polyol and natural polyol.

In some embodiments, the method can be performed with a filler selected from the group consisting of calcium sulfate dihydrate, calcium sulfate hemihydrate, anhydrous calcium sulfate, synthetic calcium sulfate dihydrate, silica fume, hydraulic cement, blast furnace slag, fly ash, metakaoline, clay, ground glass, pumice, perlite, diatomaceous earth, expanded clay, expanded shale, expanded perlite, hollow ceramic microspheres, hollow glass microspheres and gas-filled expanded acrylic microspheres and expanded polystyrene microspheres. At least some embodiments are performed as a method in which the filler is a combination of cement and calcium sulfate hemihydrate. Further embodiments include methods in which a composition for making a construction product is formulated with fibers selected from the group consisting of glass fibers, polymeric fibers, mineral wool fibers, cellulose and paper fibers.

### BRIEF DESCRIPTION OF THE DRAWINGS

FIG. 1 depicts the mold design for conducting a method for producing a product with predetermined density.

FIG. 2 depicts a cylindrical compression mold.

FIG. 3 is a plot showing compressive strength as a function of product density.

FIG. 4 is a plot comparing the compressive strength of a product made with mineral wool fibers versus a product made with the same composition, but without mineral wool fibers.

FIG. 5 is a mold for making panels.

FIG. 6 is a photograph of some panels prepared in the mold of FIG. 5.

FIG. 7 is a photograph of some panels prepared in the mold of FIG. 5.

### DETAILED DESCRIPTION

At least some of these needs are addressed by lightweight inorganic filled polyurethane compositions provided in this disclosure. These compositions can be used as a material for manufacturing a great variety of construction products with desirable physical characteristics which are much needed in industrial applications. In some embodiments, a product with a predetermined density in the range from 10 pcf to 125 pcf can be made.

In some embodiments, the lightweight inorganic filled polyurethane compositions are obtained by mixing at least one inorganic filler with at least one alcohol having two or more reactive hydroxyl groups (—OH) per molecule (example, diols, triols, polyols) and at least one isocynate having more than one reactive isocyanate group (—NC═O) per molecule (example, diisocyanates, polyisocyanates). Mixing these components together initiates an exothermic reaction between the alcohol and isocynate and cross-linking of the inorganic filler in a polyurethane matrix created by polymerization of alcohol and isocyanate. The alcohol and isocyanate can be used in various molar ratios. In some embodiments, the molar ratio between the alcohol and isocyanate is 1:1. In other embodiments, the molar ratio of the alcohol to the isocyanate is from 0.25:1 to 5:1, and preferably from 0.5:1 to 2.5:1.

Polycyclic or aromatic isocyanates are particularly preferred in the compositions of invention as they help to produce a more rigid foam structure that is useful in end applications of this invention. Selected examples of the reactive isocyantes useful in the present invention include polymethylene polyphenyl isocyanates and 4,4′-diphenylmethane diisocyanate (MDI). Examples of some other preferred isocyanates include 2,4-toluene diisocyanate (TDI), xylene diiscyanate (XDI), meta-tetramethylxylylene diisocyanate (TMXDI), hydrogenated xylene diisocyanate (HXDI), naphthalene 1,5-diisocyanate (NDI), p-phenylene diisocyanate (PPDI), 3,3′-dimethyldiphenyl-4,4′-diisocyanate (DDDI), 1,6 hexamethyl diisocyanate (HMDI), 1,6 hexamethylene diiscyanate (HDI), 2,2,4-trimethylhexamethylene diisocyanate (TMDI), isophorone diisocyanate (IPDI), 4,4′-dicyclohexylmethane diisocyanate (H₁₂MDI), norbornane diisocyanate (NDI), 4,4′-dibenzyl diisocyanate (DBDI). Fatty acid derived isocyanates such as ones derived from soybean oil or castor oil are also useful in the composition of invention as they help to produce environmentally sustainable, bio-based polyurethane composites.

Polyols with three or more hydroxyl groups are particularly preferred in the present invention. An example of useful polyol with three hydroxyl groups is one derived from reacting propane-1,2,3-triol (glycerol) and epoxyethane or epoxypropane. Polyester polyols, polyether polyols, acrylated polyols may also be used in the preferred compositions of present invention. Natural polyols such as the ones based on soybean oil or castor oil are particularly preferred in the present invention as they help to reduce the environmental burden and enhance the sustainability characteristics of the product.

The compositions of invention can have more than one type of polyol and more than one type of isocyanate. Highly branched polyester polyols are particularly preferred in the compositions of invention as they result in rigid polyurethane composites providing good heat and chemical resistance.

The type of polyols and polyisocyates and their respective amounts in the compositions of this invention are adjusted to obtain the desired product density, mechanical performance, long-term durability performance, and processing characteristics to produce a finished product. The preferred polyurethane compositions of the invention are the ones that provide a rigid foam structure and high-strength-to-density ratio upon completion of the reaction. In some embodiments, the total amount of a polyol and polyisocyate is from about 10% to about 60% of the total composition. In further embodiments, the total amount of a polyol and polyisocyate is from about 15% to about 50%. In further embodiments, the total amount of a polyol and polyisocyate is from about 20% to about 40%. In some embodiments, a polyol and polyisocyate are used in the 1:1 molar ratio. In other embodiments, a polyol and polyisocyate are used in a molar ratio ranging from 0.25:1 to 5:1, respectively.

Various inorganic fillers are suitable for the lightweight inorganic filled polyurethane compositions. In some embodiments, lightweight inorganic filled polyurethane compositions comprise calcium sulfate as a filler.

In some embodiments, the compositions of the invention utilize one or more forms of calcium sulfate as the most preferred filler. These preferred fillers include calcium sulfate dihydrate, calcium sulfate hemihydrate and anhydrous calcium sulfate. Synthetic calcium sulfate dihydrate fillers obtained as a byproduct from scrubbing of flue gases resulting from combustion of coal are particularly preferred in the present invention.

Silica fume is yet another preferred filler in the compositions of the invention. The median particle size of silica fume is around 1 micron. Fillers of at least 2-3 different sizes can be used in some embodiments. Using at least two fillers with different sizes fulfills two different goals—(a) it optimizes packing of filler particles in the cross-lined matrix; and (b) it improves fluidity.

In some embodiments, the maximum amount of filler that can be loaded is 63% by volume if all particles in the filler are of about same size. However, if two fillers are used with particles of two different sizes, the maximum amount of fillers total loaded becomes 86% by volume. If three different fillers are used with particles of three different sizes, the maximum amount of fillers becomes 95% by volume.

Thus, the inventors have developed a method which permits loading more inorganic materials. In addition to that following Krieger and Dougherty equation, the viscosity of the filler loaded precursor can be defined as, ᵣ=[1−ₘ]^{-p}, where is the viscosity of PU precursor, ₘ is maximum packing fraction of particles and p is defined as p=y. ₘ, where y is a constant. This shows that upon loading different sized particles, it is possible to effectively reduce the viscosity and improved fluidity, which in turn improves a manufacturing efficiency.

In some embodiments, the median size range of the filler chosen varies from 1-45 microns and the filler is a mixture of particles with sizes in the range from 1 to 45 microns.

Some preferred compositions contain a combination of two fillers—a calcium sulfate filler and silica fume. Hydraulic cements such as Portland cements and/or calcium aluminate cements are also used as preferred fillers in the compositions. Their presence is helpful in self-sealing any cracks that may potentially form during the actual life cycle and use of the products of this invention.

Other inorganic fillers that could be additionally used in the compositions of invention include blast furnace slag, fly ash, metakaoline and other types of clays, ground glass, pumice, perlite, diatomaceous earth, expanded clay, expanded shale, etc. Lightweight fillers such as expanded perlite, hollow ceramic microspheres, hollow glass microspheres are particularly preferred in the compositions of the invention as they help to reduce product density and weight. Organic lightweight fillers such as gas-filled expanded acrylic microspheres (example, EXPANCEL™) and expanded polystyrene microspheres may also be used in the compositions of invention to reduce product density and weight.

The preferred median particle size of lightweight fillers in the compositions of invention ranges between 10 microns and 500 microns, more preferably between 10 microns to 150 microns, and most preferably between 10 microns to 75 microns.

The amount of fillers in the compositions of invention ranges between 40 to 90 wt %, more preferably between 50 to 85 wt %, and most preferably between 60 to 80 wt %.

The compositions of this invention may also include other additives such as, but not limited to, wetting agents, catalysts, curing agents, chain extenders, crosslinkers, surfactants, moisture scavengers, viscosity modifying admixtures, plasticizers, pigments and coloring admixtures. A number of aliphatic and aromatic amines (for example, diaminobicyclooctane), organometallic compounds (for example, dibutyltin dilaurate, dibutyltin diacetate), alkali metal salts of carboxylic acids, phenols (for example, magnesium, calcium, barium, strontium salts of hexanoic, octanoic, naphthenic, linolenic acid) may be used as catalysts in the compositions of invention.

The products and compositions of this invention may be internally reinforced with one or more types of reinforcing materials. The reinforcing elements help with increasing the tensile and flexural strength of the compositions of the invention. The reinforcement in the compositions may either be continuous or discontinuous. The continuous reinforcement may be in the form of meshes or scrims made of inorganic or organic fibers such as fiberglass, polymeric fibers or natural fibers. The continuous reinforcement may also be in the form of paper or cardboard materials. High performance meshes such as those made of KEVLAR™ fibers or carbon fibers may also be used for special applications. The discontinuous fibers can be in the form of short discrete fibers made of metals, inorganic materials or organic materials. Preferred discrete fibers of the invention include glass fibers, polymeric fibers such as PVA or polypropylene, mineral wool fibers, and natural organic fibers such as cellulose or paper fibers.

Fibers can be used in various amounts. In some embodiments, from 1% to 10% of fibers, based on the total weight of the composition is used. In some embodiments, from 2% to 5% of fibers, based on the total weight of the composition is used. In some embodiments, mineral wool fibers, glass fibers, or a combination of the two are preferably used.

The compositions of this invention may also include a foaming agent or blowing agent to further reduce the density of the finished products and compositions. The blowing agent may also be added as part of the polyol, a component used for making the polyurethane matrix in the composition. Water may also be used in the compositions of invention to serve the function of a blowing agent. These agents can be used in various amounts. In some embodiments, the total amount is from 0.1% to 10% of the total composition. In other embodiments, the total amount is from 0.5% to 5% of the total composition. In further embodiments, from 0.5% to 2.5% of a foaming agent and/or blowing agent can be used.

A person of skill will appreciate that various lightweight inorganic filled polyurethane compositions can be prepared. Some of these compositions are listed in Table 1. As can be further appreciated from Table 1, composition 1 can be prepared with a combination of three different fillers: fly ash Class C, silica fume and perlite. Various other compositions with different fillers, including as provided in Table 1 below, are also contemplated.

TABLE 1
Lightweight Inorganic Filled Polyurethane (Compositions 1-7)
Material Percentage of Total Mass

| Composition | 1 | 2 | 3 | 4 | 5 | 6 | 7 |
|---|---|---|---|---|---|---|---|
| Flyash, Class C | 36.8 | — | — | 40.8 | 44.7 | 35.9 | — |
| Silica Fume | 6.6 | — | — | 6.6 | 12.8 | 6.4 | — |
| Perlite (5 pcf) | 3.9 | — | — | — | — | 3.8 | — |
| St Mary's Portland | — | 30.5 | 31.3 | — | — | — | 30.5 |
| Cement | | | | | | | |
| Calcium Sulfate | — | 45.7 | 46.9 | — | — | — | 45.7 |
| Hemihydrate | | | | | | | |
| (Alpha Form) | | | | | | | |
| USG C Base | | | | | | | |
| Gypsum Cement | | | | | | | |
| Mineral Wool | — | 2.5 | — | — | — | — | — |
| Nippon Electric | — | — | — | — | — | 2.6 | 2.5 |
| Fiberglass | | | | | | | |
| Polyisocyanate | 28.9 | 11.2 | 11.5 | 28.9 | 23.4 | 28.2 | 11.2 |
| (FOAM-IT! 3 Part A) | | | | | | | |
| Polyol | 23.7 | 10.2 | 10.4 | 23.7 | 19.1 | 23.1 | 10.2 |
| (FOAM-IT! 3 Part B) | | | | | | | |

Suitable compositions include those comprising different types of calcium sulfate fillers, including those fillers listed in Table 2 below.

TABLE 2
Lightweight Inorganic Filled Polyurethane Compositions Comprising
Different Types of Calcium Sulfate Fillers (Compositions 8-11)
Material Percentage of Total Mass

| Composition | 8 | 9 | 10 | 11 |
|---|---|---|---|---|
| Calcium Sulfate Dihydrate | 37.9-53.4 | 75.0 | — | — |
| (USG Terra Alba Filler) | | | | |
| Anhydrous Calcium Sulfate | — | — | 75.0 | — |
| (USG Snow White Filler) | | | | |
| Calcium Sulfate Hemihydrate | — | — | — | 75.0 |
| (Alpha Form) | | | | |
| USG C Base Gypsum Cement | | | | |
| Halloysite (aluminosilicate | 9.5 | — | — | — |
| nanotube) | | | | |
| Mineral Wool | 4.7 | — | — | — |
| Polyisocyanate | 23.2 | 12.5 | 12.5 | 12.5 |
| (FOAM-IT! 3 Part A) | | | | |
| Polyol | 24.6 | 12.5 | 12.5 | 12.5 |
| (FOAM-IT! 3 Part B) | | | | |

Further embodiments provide methods by which products with various densities can be obtained, which is accomplished by allowing a different degree of expansion of the lightweight inorganic filled polyurethane composition.

Some of such products were obtained by preparing a composition comprising a combination of three fillers: Class C flyash, silica fume, perlite and a combination of polyisocyanate and polyol. As shown in Table 3 below, thirteen products (PC#1 to PC#13) with densities in the range from 25.0 pcf to 47.7 pcf were obtained from a composition comprising Class C flyash (36.8%), silica fume (6.6%), perlite (3.9%), polyisocyanate (28.9%) and polyol (23.7%). The range of densities was obtained by allowing a different degree of expansion of the composition due to foaming.

TABLE 3
Products with Various Densities (PC1-PC13)

| | Composition | |
|---|---|---|
| Product Id. | # from Table 1 | Density (pcf) |
| PC#1 | 1 | 25.0 |
| PC#2 | 1 | 21.0 |
| PC#3 | 1 | 27.1 |
| PC#4 | 1 | 15.4 |
| PC#5 | 1 | 18.2 |
| PC#6 | 1 | 31.7 |
| PC#7 | 1 | 30.9 |
| PC#8 | 1 | 47.7 |
| PC#9 | 1 | 42.9 |
| PC#10 | 1 | 38.2 |
| PC#11 | 1 | 36.8 |
| PC#12 | 1 | 26.0 |
| PC#13 | 1 | 26.1 |

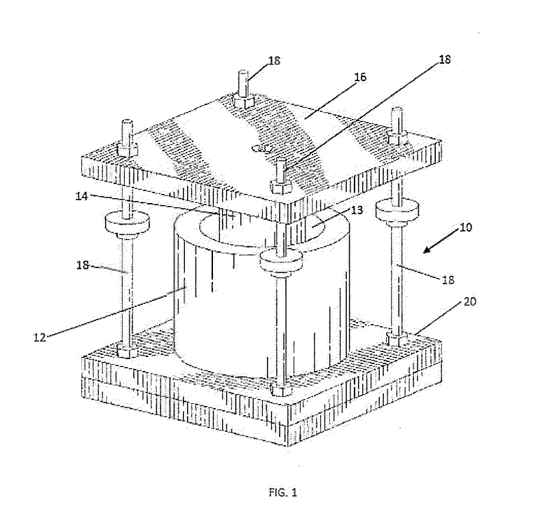

Some embodiments provide a method of mixing and curing. This method comprises a step of using a uniquely designed and fabricated compression mold. One embodiment for the mold design is provided in FIG. 1, generally 10. A person of skill will appreciated that in the embodiment of FIG. 1, the mold body 12 is cylindrical and has a central lumen 13. However, the shape of the body 12 can be any shape, including but not limited to, cylindrical, square, oval or any other shape needed for a particular panel. The mold 10 has a central cylinder 14 which fits inside the lumen 13 of the body 12 and which can be moved up and down inside the lumen 13. While the cylinder 14 is at least partially inside the lumen 13, at least a portion of the cylinder 14 may protrude outside the lumen 13 as shown in FIG. 1. The cylinder 14 is in contact with a central portion of a plate 16 which covers the cylinder 14 on the end protruding from the mold body 12. The plate 16 has a set of legs, each leg labeled as 18. The legs 18 connect the plate 16 to a second plate 20 which is positioned under the cylindrical body 12. The plate 16 can be moved up and down along the legs 18. Moving the plate 16 down the legs 18 and toward the plate 20, causes an increase in pressure on the cylinder 14 from the plate 16, which then increases the pressure inside the lumen 13.

During manufacturing a product, any composition of invention is poured inside the lumen 13, the pressure is then applied by pushing the cylinder 14 with the plate 16 into the lumen 13. This causes compression which regulates the amount of foam in the product and therefore, product's density. If more compression is applied, more foam is squeezed out. Thus, the product has a higher density product in comparison to a product made from the same composition, but to which less pressure is applied during molding. It will be appreciated, that any compression mold can be suitable for performing a method of invention. Such compression molds include any molds to which a pressure can be applied by any means known to a person of skill. At least some of these compression molds may be further in communication with a computer processor and sensor which senses the amount of pressure applied and then adjust the amount of pressure applied to achieve a predetermined density for a product molding.

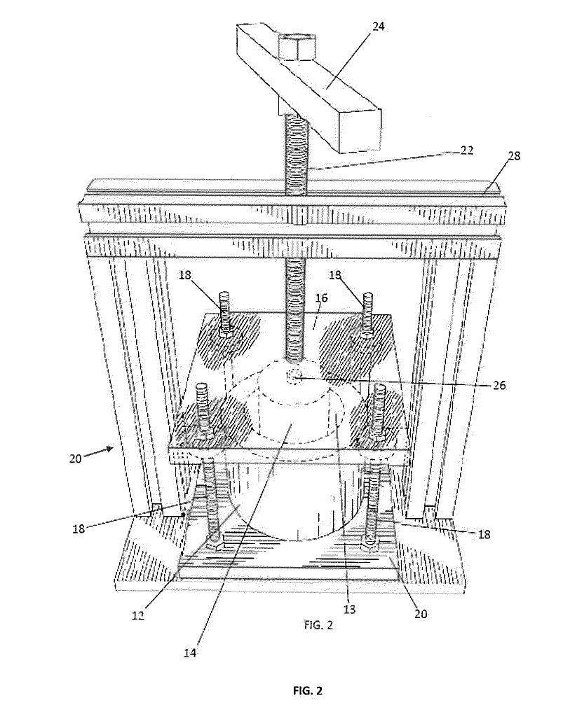

FIG. 2 is another embodiment for a compression mold, generally 20, which can be used for making a product with a predetermined density according to a method of this invention. The mold 20 has an additional screw 22 which can be screwed in the center 26 of the cylinder 14. The screw 22 ends with a handle 24 on the opposite end. By rotating the handle 24, it is possible to cause some additional compressive pressure on the cylinder 14 through the screw 22. A post 28 can be further added and hold the screw 22 in place such that the pressure is evenly distributed over a product molding inside the mold body 18. After the pressure is applied to the cylinder 14, the cylinder 14 presses inside the lumen 13 and compresses any composition of the invention which was poured in the lumen 13. Thus, it is possible to regulate the compressive pressure applied to a molding product and therefore, to regulate the density of the product while the product is molding in the mold 20.

It will be appreciated that molds of FIGS. 1 and 2 are cylindrical, however, a mold can be designed in any shape, based on a product to be made.

Construction products must meet certain compressive strength requirements in order to be suitable for a purpose for which they are made. The present methods allow manufacturing of products with different compressive strength. Importantly, any one composition of the invention can be used for producing a great variety of products with a compressive strength needed. This can be achieved by adjusting the density of a product during molding. Thus, the same composition can be used for making products with a compressive strength in the range from 10 pcf to 125 pcf.

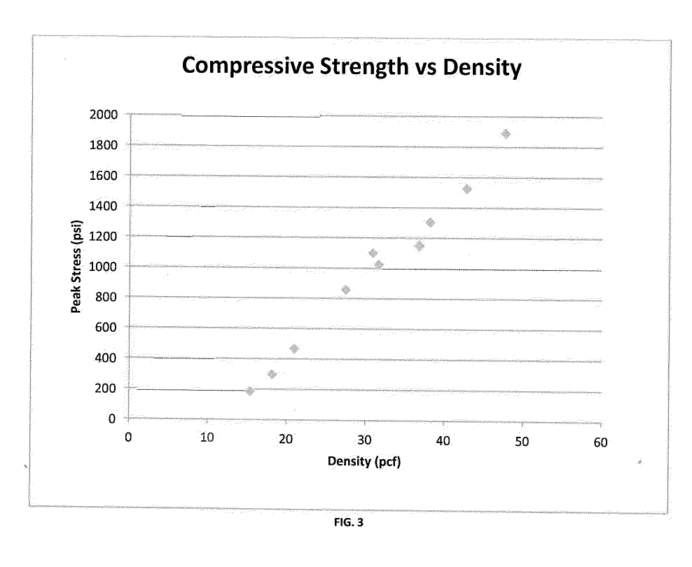

As shown in Table 4 and FIG. 3, the compressive strength of a product is a function of the product density.

TABLE 4
Compressive Strength Data over a Range of Densities

| | | | Peak |
|---|---|---|---|
| | | PeakLoad | Compressive |
| Product Id. | Density (pcf) | (lbf) | Stress (psi) |
| PC#4 | 15.4 | 1294.6 | 188 |
| PC#5 | 18.2 | 2082.8 | 303 |
| PC#2 | 21 | 3241.2 | 471 |
| PC#3 | 27.5 | 5919.8 | 860 |
| PC#7 | 30.9 | 7584.8 | 1102 |
| PC#6 | 31.7 | 7075.0 | 1028 |
| PC#11 | 36.8 | 7908.4 | 1149 |
| PC#10 | 38.2 | 8992.2 | 1307 |
| PC#9 | 42.8 | 10505.3 | 1527 |
| PC#8 | 47.7 | 13012.7 | 1891 |

The inventors have developed a method which allows to determine a correlation between density and compressive strength for a product made from any composition of this invention. In one embodiment for the method, a number of product specimens with a range of densities is made from the same composition by changing the amount of pressure applied to each product during molding. After products have solidified, they are removed from molds and the density for each product can be measured and recorded. The compressive strength for each product is then determined by the peak load test. The data from the peak load test is then converted into compressive strength and plotted as a function of density as shown in FIG. 3. The plot of FIG. 3 can be used for determining what density would be needed to achieve any particular compressive strength. This method allows making products which are light weight, yet meet the compressive strength needed for a particular construction purpose.

The compositions of this invention can be used for obtaining products with high density. In some embodiments, a product can be made with a density in the range from about 40 pcf to about 90 pcf. In further embodiments, a product can be made with a density in the range from about 50 pcf to about 90 pcf. At least some products have a density in the range from about 10 pcf to about 125 pcf. Other products have a density in the range from about 15 pcf to about 100 pcf. Yet other products have a density in the range from about 15 pcf to about 90 pcf. Yet other products have a density in the range from about 20 pcf to about 80 pcf. Yet other products have a density of at least 50 pcf, but less than 100 pcf. Yet other products have a density of at least 55 pcf, but less than 95 pcf. Yet other products have a density of at least 60 pcf, but less than 80 pcf. Yet other products have a density of at least 65 pcf, but less than 80 pcf.

These products can be prepared with any of the compositions of the invention. In some embodiments, a product can be made with a composition comprising cement and calcium sulfate hemihydrate. In further embodiments, some fibers can be added to the composition. Any of the polyurethane binders can be used in the compositions. In some embodiments, a combination of polyisocyanate and polyol is used as a binder.

Some products with a density in the range from about 50 pcf to about 85 pcf can be prepared with compositions 2 and 3 of Table 1. Such products include those listed in Table 5 below.

TABLE 5
The Range of Densities for Products
Made With Cement and Gypsum

| | | Density (pcf) | | | |
|---|---|---|---|---|---|
| Product | Composition # | Specimen | Specimen | Specimen | Specimen |
| Id. | Of Table 1 | 1 | 2 | 3 | 4 |
| PC#14 | 2 | 83.6 | 78.6 | | |
| PC#15 | 2 | 67.1 | 67.3 | 58.7 | |
| PC#16 | 3 | 51.2 | | | |
| PC#17 | 3 | 58.8 | 58.6 | 65.2 | 56.6 |

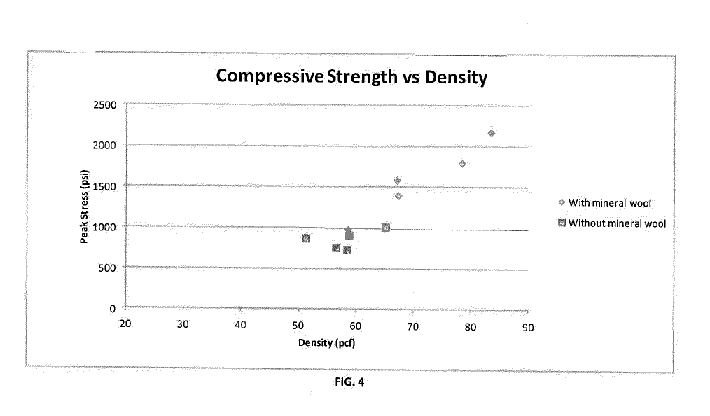

The compressive strength of a product can be further increased by using a composition of invention, comprising fibers. As shown in FIG. 4 and Table 6 in comparison to Table 7, the compressive strength of a product can be increased by adding fibers to a composition of invention.

TABLE 6
Compressive Strength of Products Made With Composition
2 of Table 1, Comprising Mineral Wool

| | Density | PeakLoad | PeakStress |
|---|---|---|---|
| Product Id. | (lb/ft\hat{ }3) | (lbf) | (psi) |
| 14-1 | 83.4 | 8760.8 | 2190 |
| 14-2 | 78.4 | 7247.8 | 1812 |
| 15-1 | 67.1 | 6414.5 | 1604 |
| 15-2 | 67.3 | 5666.7 | 1417 |
| 15-3 | 58.6 | 3956.0 | 989 |

TABLE 7
Compressive Strength of Products Made with Composition
3 of Table 1, without Mineral Wool

| | Density | PeakLoad | PeakStress |
|---|---|---|---|
| Product Id. | (lb/ft\hat{ }3) | (lbf) | (psi) |
| 16-1 | 51.2 | 3552.2 | 888 |
| 17-1 | 58.8 | 3670.6 | 918 |
| 17-2 | 58.4 | 2997.9 | 749 |
| 17-3 | 65.1 | 4084.4 | 1021 |
| 17-4 | 56.5 | 3103.2 | 776 |

Further embodiments of this invention contemplate a great variety of products made with any of the compositions of this invention. Physical properties, including, but not limited to, density, flexibility, compressive strength and fire-resistance, of inorganically filled polyurethane products and compositions of this invention can be adjusted to a product application for which the product is to be made.

One embodiment provides flat panels which are produced in accordance with this invention. The thickness of panels can range from ⅛ inch to 5 inches, more typically ¼ inch to 2 inches, and most typically, ¼ inch to 1 inch. When flat panels are produced in accordance with this invention, the width of the panels can range anywhere from 4 inches to 240 inches, more typically 6 inches to 120 inches, and most typically, 9 inches to 60 inches. When flat panels are produced in accordance to this invention, the length of the panels can range anywhere from 4 inches to 240 inches, more typically 6 inches to 120 inches, and most typically, 9 inches to 60 inches. The panels of this invention may have a tapered profile wherein the thickness of the panels varies across the width (or length) of the panel. The top and/or bottom surfaces of the panel of this invention may be either smooth or textured (patterned). The panels of this invention may have one or more profiles (grooves, bevels, etc.) cut on one or both broad surfaces of the panel (i.e., top and bottom surfaces). The panels of this invention may also have a tongue and/or groove profiled edges for interlocking of adjacent panels. Three-dimensional building components (non-flat elements) may also be produced using the compositions of the invention.

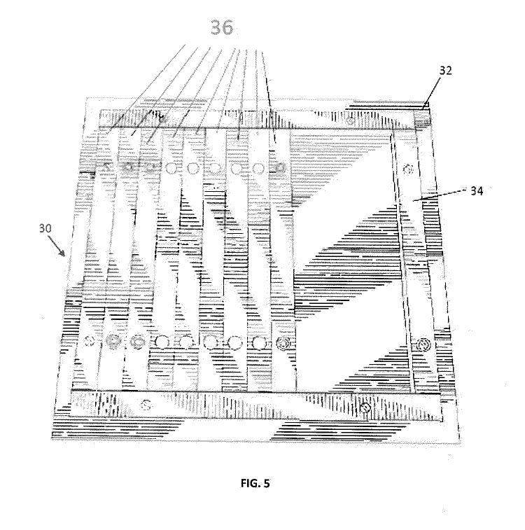

Various flat panels can be produced by formulating any of the compositions of this invention and pouring the formulation into a mold. Various molds can be used for manufacturing the panels. Such molds include a mold shown in FIG. 5. As can be appreciated from FIG. 5, the mold, generally 30, comprises a forming plate 32 and a frame 34 which is placed on top of the plate 32. Any composition of the invention can be poured in the frame 34 and will be allowed to set. A person of skill will appreciate that the size of the frame 34 controls the thickness, length and width of a panel made in the mold 30. Thus, panels of any predetermined shape and size can be manufactured by preparing a frame 34 for the mold 30 accordingly.

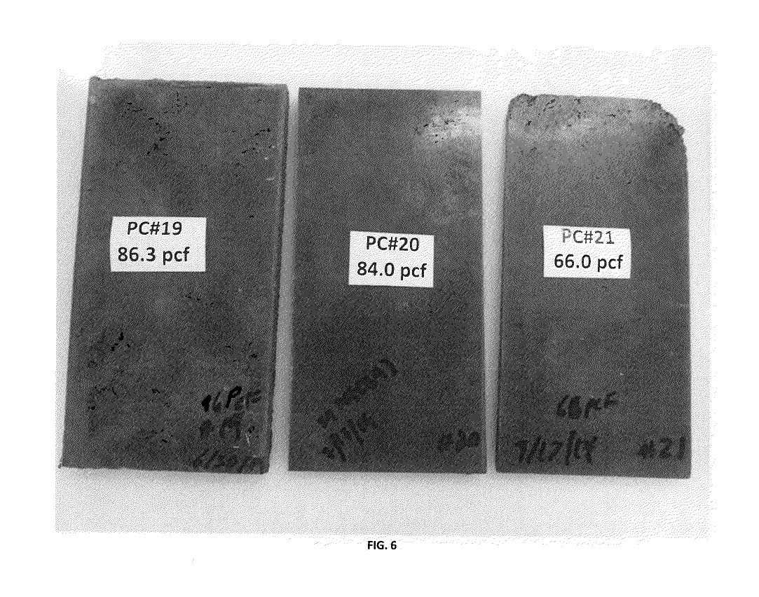

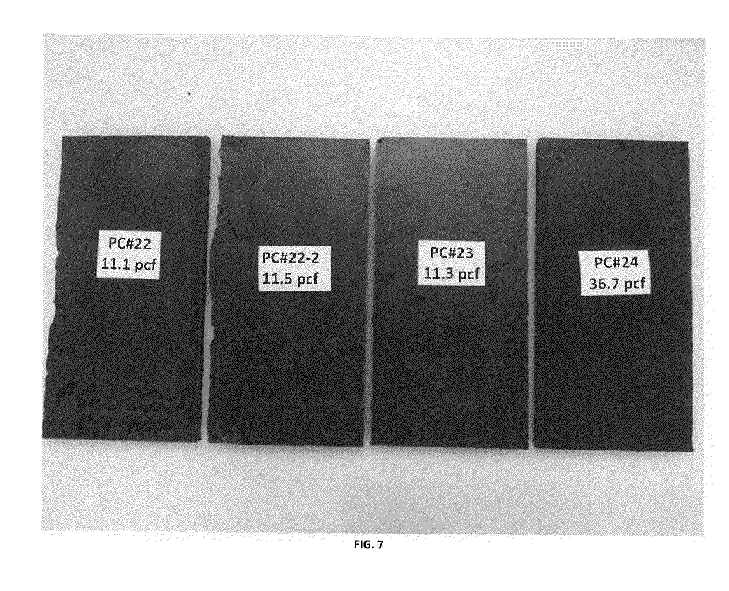

The frame 34 contains a set of borders 36, each of which fits in the frame 34 and can be added or removed from the frame 34. When a full set of borders 36 is placed in the frame 34, a panel with a certain width is made. By removing at least one boarder 36 from the frame 34, it is possible to increase the width of the panel. FIGS. 6 and 7 show some panels produced by using the mold shown in FIG. 5. It will be appreciated that while the mold of FIG. 5 is suitable for making flat panels. A mold can be also designed for making non-flat panels. Such molds may include those in which the plate 32 is not flat and rather has a shape needed for molding a panel with features, i.e. grooves, bends, creases and the like.

As can be appreciated from Table 8 below, panels with a broad range of densities can be produced, using compositions of Table 1. Table 8 reports a density in the range from about 10 pcf to about 90 pcf for panels made with composition 1, 3, 4, 5, 6 or 7 of Table 1.

TABLE 8
The Range of Densities

Density (pcf)

| | Composition | Specimen | Specimen |
|---|---|---|---|
| Product Id. | # of Table 1 | 1 | 2 |
| PC#19 | 3 | 86.3 | |
| PC#20 | 3 | 84.0 | |
| PC#21 | 3 | 66.0 | |
| PC#22 | 1 | 11.1 | 11.5 |
| PC#23 | 4 | 11.3 | |
| PC#24 | 5 | 36.7 | |
| PG#25 | 6 | 14.2 | |
| PC#26 | 7 | 83.6 | |

Some of the products listed in Table 8 are also shown in FIGS. 6 and 7. Construction products need to be fire-resistant. The inventors have discovered that products obtained with a composition of this invention, including very light products with a density of about 10 pcf, 11 pcf, 12 pcf and 13 pcf, have low thermal conductivity and superior thermal resistance. Such panels with low thermal conductivity and superior thermal resistance include those listed in Table 9 below.

TABLE 9
Thermal Conductivity and Resistance Properties of Panels

| Product | Composition | Density | Sample | Mean | Λ [k] | R-Value |
|---|---|---|---|---|---|---|
| Id. | # of Table 1 | (pcf) | Thickness | Temperature | (W/m*K) | (h*ft\hat{ }2*° F./Btu) |
| PC#1 | 3 | 66.0 | 0.5052 in | 73.43° F. | 0.0613 | 0.35 |
| PC#23 | 4 | 11.3 | 0.522 in | 73.43° F. | 0.04643 | 1.61 |

Another important characteristic of a construction product is its flexural strength. As can be appreciated from Table 10 below, products of this invention have excellent flexural strength. It is particularly noteworthy that formulating a product with fibers such as for example, glass fibers improves the flexural strength of a product.

TABLE 10
Flexural Strength of Products

| Product | Composition # | | Flexural Strength |
|---|---|---|---|
| ID/Specimen # | of Table 1 | Density (pcf) | (psi) |
| PC#22-1 | 1 | 11.1 | 125 |
| PC#22-2 | 1 | 11.1 | 226 |
| PC#22-3 | 1 | 11.1 | 91 |
| PC#25-1 | 6 | 14.2 | 73 |
| PC#25-2 | 6 | 14.2 | 141 |
| PC#25-3 | 6 | 14.2 | 95 |
| PC#20-1 | 3 | 84.0 | 1663 |
| PC#20-2 | 3 | 84.0 | 1243 |
| PC#20-3 | 3 | 84.0 | 1523 |
| PC#26-1 | 7 | 83.6 | 1930 |
| PC#26-2 | 7 | 83.6 | 1441 |
| PC#26-3 | 7 | 83.6 | 1696 |

Further embodiments include products coated with a surface coating to provide enhanced performance characteristics in the actual application. The typical coatings applied on the products of invention help to prime and seal the panel surface and provide improved water resistance and enhanced bonding performance to different types of adhesives such as cementitious mortars, organic adhesives, epoxies, etc. Special coatings may also be utilized to enhance the wear resistance of the product. Special intumescent coatings may be used to further enhance the fire-resistance characteristics of the product.

The inorganically filled polyurethane products and compositions of this invention can be used for a variety of applications including any of the following:
Backerboards for installation of floor coverings such as ceramic tiles, stones, resilient floor coverings, carpet, etc.
   For backerboard applications (walls and floors), products with densities ranging from 5 pcf to 50 pcf are most preferred.
Exterior wall sheathing for application of cementitious basecoats and other finish covering materials
For exterior wall sheathing applications, products with densities ranging from 25 pcf to 75 pcf are most preferred.
Roof cover boards
   For roof cover board applications, products with densities ranging from 10 pcf to 60 pcf are most preferred.
Structural flooring panels for transverse and diaphragm loads.
   For structural flooring panel applications, products with densities ranging from 40 pcf to 80 pcf are most preferred.
Structural wall panels for racking/diaphragm loads.
   For structural wall panel applications, products with densities ranging from 40 pcf to 80 pcf are most preferred.
Roofing panels for transverse and diaphragm loads.
   For structural flooring panel applications, products with densities ranging from 40 pcf to 80 pcf are most preferred.
Architectural wall panels and elements for building facades
   For architectural wall panel applications, products with densities ranging from 30 pcf to 80 pcf are most preferred.
Exterior wall sidings and trims
   For exterior wall sidings and trims applications, products with densities ranging from 25 pcf to 75 pcf are most preferred.
Roofing tiles
   For roofing tiles applications, products with densities ranging from 25 pcf to 75 pcf are most preferred.
Ceiling tiles for suspended ceilings
   For ceiling tile applications, products with densities ranging from 5 pcf to 20 pcf are most preferred.
Insulation panels
   For insulation panel applications, products with densities ranging from 5 pcf to 25 pcf are most preferred.
Acoustical panels for sound-deadening in flooring applications
   For acoustical panel applications, products with densities ranging from 2.5 pcf to 25 pcf are most preferred.
Sandwich insulation panels with polyurethane core
   For sandwich insulation panel applications, products with densities ranging from 10 pcf to 50 pcf are most preferred.
Sandwich insulation panels can be from 2 inches up to 10 inches thick
Facing materials with sandwich insulation panels can be any one or combination of the following:
   Flexible facers: Paper, non-woven fibrous mat such as that made of glass fibers, cardboard, metal such as aluminium sheet, etc.
   Rigid facers: Cement-based panels, gypsum-based panels, gypsum-fiber panels, metal sheets, fiber reinforced plastic sheets
Synthetic stones and synthetic tiles
   For synthetic stone and synthetic tile applications, products with densities ranging from 25 pcf to 125 pcf are most preferred.
Synthetic Wood
   For synthetic wood applications, products with densities ranging from 25 pcf to 50 pcf are most preferred.
Waterproofing panels and systems in wet areas of buildings
   For waterproofing panel applications, products with densities ranging from 5 pcf to 50 pcf are most preferred.

Further embodiments provide methods for attaching products and composites prepared from any composition of this invention to substrates. The inorganically filled polyurethane products and composites of this invention can be applied to the framing using conventional fasteners such as nails, screws, or staples. The products and panels of this invention may also be bonded to another substrate or themselves (when using multiple layers) using different types of adhesives such as thin-set mortars, organic adhesives, epoxies, etc.

The inorganically filled polyurethane products and composites of this invention can be manufactured using one or more of the following production processes for producing polymer-based composites:
Continuous Extrusion Processes
   Continuous extrusion processes capable of producing products of this invention are commercially offered by companies such as Uniloy Milacron Germany GmbH, Grossbeeren, Germany or Friul Filiere S.p.A., Buia, Italy or KraussMaffei, Munich, Germany.
Continuous Foaming Lamination Process for producing sandwich panels (such as sandwich insulation panels)
   Regular polyurethane panels or sandwich insulation panels can be produced using a continuous foaming method. These types of manufacturing processes capable of producing products of this invention are commercially offered by companies such as Canon, USA, Cranberry Twp., Pa. or Afros S.p.A., Caronno Pertusella, Italy.
Discontinuous Foaming Methods such as Presses for producing regular or sandwich panels (such as sandwich insulation panels)
   Regular polyurethane panels or sandwich insulation panels can be produced using a continuous foaming laminator or with discontinuous foaming methods such as presses. These types of manufacturing processes capable of producing products of this invention are commercially offered by companies such as Canon, USA or Afros S.p.A., Caronno Pertusella, Italy.
Injection Molding Processes
   Injection Molding Processes are commercially offered by companies such as Uniloy North America, Tecumseh, Mich. or Uniloy Milacron Sri, Magenta, Italy.
Compression Molding Process
Calendering Process
Spraying Process
Casting Process

The invention will be now explained in more detail by the way of the following non-limiting examples.

### Example 1

A composition comprising Class C flyash (36.8%), silica fume (6.6%), perlite (3.9%), polyisocyanate (28.9%) and polyol (23.7%) was prepared. A mold shown in FIG. 2 was used to prepare ten product specimens with densities in the range from 15.4 to 47.7 pcf. The density for each product was recorded in Table 4. The peak load test was conducted for each specimen, and data from this test are recorded in Table 4. The peak load values were converted into compressive stress values and potted as a function of densities, as shown in FIG. 3. Thus, a basic correlation between the density and compressive strength was established. The plot of FIG. 3 can be used for determining a density needed for obtaining a product with any particular compressive strength from a composition comprising Class C flyash (36.8%), silica fume (6.6%), perlite (3.9%), polyisocyanate (28.9%) and polyol (23.7%).

### Example 2

A composition comprising St. Mary's Portland Cement (30.5%) and Calcium Sulfate Hemihydrate (45.7%) was prepared by mixing with polyisocyanate (11.2%) and polyol (10.2%). Mineral wool fibers were added to the composition in the amount of 2.5%. See composition 2 in Table 1. Products were molded as 2″×2″ cubes and were allowed to set.

A composition comprising St. Mary's Portland Cement (31.3%) and Calcium Sulfate Hemihydrate (46.9%) was prepared by mixing with polyisocyanate (11.2%) and polyol (10.4%). No mineral wool fibers was added to the composition. See composition 3 in Table 1. Products were molded as 2″×2″ cubes and were allowed to set.

A density was measured for each of the products and the results are reported in Table 5. A higher density was achieved for products made with a composition comprising mineral wool fibers in comparison to products made without mineral wool fibers. Compare products 14 and 15 made with mineral wool fibers to products 16 and 17 made without mineral wool fibers in Table 5.

A series of compression tests was performed for products listed in Table 5. The tests were conducted as was described in connection with Example 1, and results are reported in Tables 6 and 7, and FIG. 4. As can be appreacited from FIG. 4, mineral wool fibers improve the compressive strength of a product.

### Example 3

Compositions 1, 3, 4, 5, 6, and 7 of Table 1 were prepared. Flat 6″×12″ panels with thickness of 0.75″ were then molded by using a mold shown in FIG. 5. After panels were completely set, the density for each panel was measured and recorded in Table 8. Some of the products listed in Table 8 are also shown in FIGS. 6 and 7. Thermal conductivity and resistance properties of the panels were measured and some of these measurements are reported in Table 9 below. Flexural strength of the panels was also measured and recorded in Table 10.

What is claimed is:

1. A construction product with a density in the range from about 10 pcf to about 125 pcf and comprising an inorganic filler cross-linked in a polyurethane matrix produced by an exothermic reaction between at least one alcohol having two or more reactive hydroxyl groups per molecule and at least one isocyanate having more than one reactive isocyanate group per molecule, wherein a molar ratio of the alcohol to the isocyanate is in the range from 0.25:1 to 5:1.

2. The construction product of claim 1, wherein the construction product is selected from the group consisting of a flat panel, a three-dimensional building component, a backboard, an exterior wall sheathing, roof cover board, flooring panel, architectural wall panel, architectural element for building façade, synthetic wood and synthetic tile.

3. The construction product of claim 1, wherein the filler is a combination of fly ash, silica fume and perlite.

4. The construction product of claim 1, wherein the isocyanate is selected from the group consisting of polycyclic and aromatic isocyanates.

5. The construction product of claim 1, wherein the isocyanate is a fatty-acid derived isocyanate.

6. The construction product of claim 1, wherein the isocyanate is selected from the group consisting of polymethylene polyphenyl isocyanates and 4,4′-diphenylmethane diisocyanate (MDI).

7. The construction product of claim 1, wherein the isocyanate is selected from the group consisting of 2,4-toluene diisocyanate (TDI), xylene diiscyanate (XDI), meta-tetramethylxylylene diisocyanate (TMXDI), hydrogenated xylene diisocyanate (HXDI), naphthalene 1,5-diisocyanate (NDI), p-phenylene diisocyanate (PPDI), 3,3′-dimethyldiphenyl-4,4′-diisocyanate (DDDI), 1,6 hexamethyl diisocyanate (HMDI), 1,6 hexamethylene diiscyanate (HDI), 2,2,4-trimethylhexamethylene diisocyanate (TMDI), isophorone diisocyanate (IPDI), 4,4′-dicyclohexylmethane diisocyanate (H₁₂MDI) and norbornane diisocyanate (NDI), 4,4′-dibenzyl diisocyanate (DBDI).

8. The construction product of claim 1, wherein the alcohol is a polyol selected from the group consisting of: a polyol obtained by reacting propane-1,2,3-triol (glycerol) and epoxyethane, a polyol obtained by reacting propane-1,2,3-triol (glycerol) and epoxypropane, polyester polyol, polyether polyol, acrylated polyol and natural polyol.

9. The construction product of claim 1, wherein the filler is selected from the group consisting of calcium sulfate dihydrate, calcium sulfate hemihydrate, anhydrous calcium sulfate, synthetic calcium sulfate dihydrate, silica fume, hydraulic cement, blast furnace slag, fly ash, metakaoline, clay, ground glass, pumice, perlite, diatomaceous earth, expanded clay, expanded shale, expanded perlite, hollow ceramic microspheres, hollow glass microspheres and gas-filled expanded acrylic microspheres and expanded polystyrene microspheres.

10. The construction product of claim 1, wherein the product further comprises fibers selected from the group consisting of glass fibers, polymeric fibers, mineral wool fibers, cellulose and paper fibers.

11. A method of making a construction product with a predetermined density, the method comprising:
e) mixing a composition comprising at least one inorganic filler, at least one polyol and at least one polyisocyante;
f) pouring the composition into a mold;
g) applying compressive pressure to the mold, wherein the amount of compressive pressure applied is calculated such that to obtain a construction product with a pre-determined density; and
h) allowing the product to set.

12. The method of claim 11, wherein the density is in the range from 10 pcf to 125 pcf.

13. The method of claim 11, wherein the composition is formulated with at least two inorganic fillers selected from the group consisting of flyash class C, silica fume, perlite, cement, calcium sulfate hemihydrate, calcium sulfate dihydrate and calcium sulfate anhydrate.

14. The method of claim 11, wherein the product is selected from the group consisting of a flat panel, a three-dimensional building component, a backboard, an exterior wall sheathing, roof cover board, flooring panel, architectural wall panel, architectural element for building façade, synthetic wood and synthetic tile.

15. The method of claim 11, wherein the isocyanate is selected from the group consisting of polymethylene polyphenyl isocyanates and 4,4′-diphenylmethane diisocyanate (MDI).

16. The method of claim 11, wherein the isocyanate is selected from the group consisting of 2,4-toluene diisocyanate (TDI), xylene diiscyanate (XDI), meta-tetramethylxylylene diisocyanate (TMXDI), hydrogenated xylene diisocyanate (HXDI), naphthalene 1,5-diisocyanate (NDI), p-phenylene diisocyanate (PPDI), 3,3′-dimethyldiphenyl-4,4′-diisocyanate (DDDI), 1,6 hexamethyl diisocyanate (HMDI), 1,6 hexamethylene diiscyanate (HDI), 2,2,4-trimethylhexamethylene diisocyanate (TMDI), isophorone diisocyanate (IPDI), 4,4′-dicyclohexylmethane diisocyanate (H₁₂MDI) and norbornane diisocyanate (NDI), 4,4′-dibenzyl diisocyanate (DBDI).

17. The method of claim 11, wherein the alcohol is a polyol selected from the group consisting of: a polyol obtained by reacting propane-1,2,3-triol (glycerol) and epoxyethane, a polyol obtained by reacting propane-1,2,3-triol (glycerol) and epoxypropane, polyester polyol, polyether polyol, acrylated polyol and natural polyol.

18. The method of claim 11, wherein the filler is selected from the group consisting of calcium sulfate dihydrate, calcium sulfate hemihydrate, anhydrous calcium sulfate, synthetic calcium sulfate dihydrate, silica fume, hydraulic cement, blast furnace slag, fly ash, metakaoline, clay, ground glass, pumice, perlite, diatomaceous earth, expanded clay, expanded shale, expanded perlite, hollow ceramic microspheres, hollow glass microspheres and gas-filled expanded acrylic microspheres and expanded polystyrene microspheres.

19. The method of claim 11, wherein fibers are mixed into the composition and fibers are selected from the group consisting of glass fibers, polymeric fibers, mineral wool fibers, cellulose and paper fibers.

20. The method of claim 11, wherein the filler is a combination of cement and calcium sulfate hemihydrate.
